(19) United States
(12) Patent Application Publication
(10) Pub. No.: US 2020/0277212 A1
(43) Pub. Date: Sep. 3, 2020

(54) BROWN GREASE TREATMENT AND DISPOSAL SYSTEM

(71) Applicant: Water Envirornmental Technology, Louisville, TX (US)

(72) Inventors: William Michael Fields, Highlands Ranch, CO (US); Yuanchun Xu, Highlands Ranch, CO (US); Guichun Zhang, Highlands Ranch, CO (US)

(21) Appl. No.: 16/646,697

(22) PCT Filed: Sep. 14, 2018
(86) PCT No.: PCT/US2018/050996

§ 371 Date: Mar. 12, 2020

Related U.S. Application Data
(60) Provisional application No. 62/558,569, filed on Sep. 14, 2017.

(51) Int. Cl. C02F 9/00; B01D 17/02; B01D 17/04; B03D 1/14

(52) U.S. Cl. CPC C02F 9/00; B01D 17/0205; B01D 17/0217; B01D 17/042; C02F 3/1247; B03D 1/1406; B03D 1/1431; B03D 1/1462; B03D 1/1475; B01D 17/0211

(57) ABSTRACT

A system for recovering fat, oil and grease and removing biochemical oxygen demand and total suspended solids from brown grease or trap grease. In some cases, the system includes an integrated inlet coarse screen, primary circular zoned dissolved air and ozone flotation unit, bio-dissolved air and flotation unit, and three-phase centrifuge.

### CROSS-REFERENCE TO RELATED APPLICATION(S)

This application is a U.S. national stage application under 35 USC § 371 of International Application No. PCT/US18/50996 filed on Sep. 14, 2018 and entitled “BROWN GREASE TREATMENT AND DISPOSAL SYSTEM,” which claims priority to U.S. Provisional Application No. 62/558,569 filed on Sep. 14, 2017 and entitled “Brown Grease Treatment and Disposal System for Restaurants and Food Establishments,” the entire contents of which are incorporated herein by reference.

### BACKGROUND

Today, it is estimated that 495 million gallons of brown or trap grease is generated annually in the U.S. If the trap grease is not properly disposed of, fat, oil, and grease (FOG) can accumulate in downstream sewage pipes causing clogs and sanitary sewer overflows (SSOs). FOGs are sticky and easily accumulate along the inside walls of sewage pipes, eventually hardening to form a concrete-like substance. FOG accumulation is one of the primary causes of SSOs. The resulting cost of cleaning up clogs, SSOs and repairing damage to pumping stations can be quite high. Taxpayers typically bear these costs in the form of increased water and sewage service rates.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates a block diagram view of an example resource recovery system for processing wastewater according to some implementations.

FIG. 2 illustrates a cross-sectional view of the example the primary circular zoned dissolved air and/or ozone flotation (CZDAOF) unit of FIG. 1 according to some implementations

FIG. 3 illustrates a top view of an example the primary CZDAOF unit of FIG. 1 with scum scraper assembly removed according to some implementations.

FIG. 4 illustrates a top view of an example the primary CZDAOF unit of FIG. 1 according to some implementations.

FIG. 5 illustrates a partial view of an example resource recovery system of FIG. 1 including the primary CZDAOF unit, the primary gaseous material dissolving system, and the primary weir tank according to some implementations.

FIG. 6 illustrates a top view of the example bio-DAF unit of FIG. 1 according to some implementations.

FIG. 7 illustrates a cross-sectional view of the bio-DAF unit of FIG. 1 according to some implementations.

FIG. 8 illustrates a partial view of an example bio-DAF unit of FIG. 1 according to some implementations.

FIG. 9 illustrates an example flow diagram showing a process for forming finished oil and dry solids according to some implementations.

### DETAILED DESCRIPTION

This disclosure includes techniques and implementations for cleaning and recovering fat, oil, and grease (FOG) from wastewater. In particular, the system discussed herein is configured to remove and recover organic matter from wastewater produced as part of restaurant food processing. For instance, the system may be used for removing and recovering fat, oil, and grease (FOG) from restaurant brown grease to produce usable biodiesel feedstocks and fertilizer, and further treating the wastewater to meet downstream city sewer, municipal wastewater treatment plants (WWTP), or publicly owned treatment works (POTW) discharge limits for biochemical oxygen demand (BOD) and total suspended solids (TSS).

In general, brown grease, also known as trap grease, is collected from grease traps that are typically installed in restaurants, cafeteria, fast-food restaurant chains, and institutional food establishments to separate FOG from kitchen wastewater. Brown grease is a byproduct of cooking and comes from meat fats, lard, oil, shortening, butter, margarine, food scraps, baked goods, sauces, and dairy products. Brown grease is a mixture of FOG, food particulates, water, kitchen waste, grit, rocks and debris that has gone down a drain and been trapped in a grease trap or grease interceptor.

A grease trap works by slowing down the flow of warm/hot greasy water and allowing the water to cool. As the water cools, the grease and oil separate and float to the top of the grease trap. The cooler water with less FOG content continues to flow down the pipe to the sewer, WWTP, or other POTW. The FOG is trapped by baffles that cover the inlet and outlet of the grease trap tank, thereby preventing FOG from flowing out of the grease trap. However, if grease traps are not periodically emptied, the grease traps eventually become full, pushing the higher content FOG water downwards and out into the sewer system. FOG is sticky and can easily accumulate along the inside walls of sewage pipes, eventually hardening to form a concrete-like sub stance.

In most of states, grease traps or interceptors are mandated to be emptied or cleaned when FOG contents fill up 25% of the grease trap's working volume, or at least once in every three months. Unfortunately, restaurants often fail to maintain or meet the government imposed cleaning requirements. This failure is a major cause of accumulation of FOGs in downstream sewage pipes. In fact, FOG accumulation is one of the primary causes of sanitary sewer overflows (SSOs). The resulting cost of cleaning up clogs, SSOs and repairing damage to pumping stations is substantial and often the taxpayers bear these costs in the form of increased water and sewage service rates.

In addition to causing SSOs, FOG also presents a problem for downstream POTW or WWTP. FOGs can build up in inlet coarse screens and fine screens, settling tanks, digesters, and other surfaces at the plant. Since many WWTPs are not equipped to clean FOG, the FOG build-up results in decreased treatment efficiency, and WWTP must then be upgraded and outfitted with the appropriate equipment. FOG accumulation also contributes to odor generation and hydrogen sulfide problems.

Many existing brown grease handling facilities are old and use out-of-date technologies. In many cases, several tanks are connected in series to skim FOG off brown grease. The FOG removal efficiency is usually very poor and the treated wastewater still contains very high FOG, BOD, and TSS loadings. When the treated wastewater is discharged into the sewer, the municipality may apply substantial surcharge fees based on these excessive FOG, BOD, and TSS loadings. If the downstream POTW is not equipped with FOG removal and handling equipment, the brown grease handling facility is often mandated to install pretreatment equipment to meet predetermined discharge criteria. Otherwise, the POTW may refuse to receive wastewater from the brown grease handling facility or restaurant.

Thus, the system, discussed herein, provides a sustainable, integrated, compact, modular, environmentally and economically efficient system for removing and recovering FOG from brown grease. In some implementations, the system may be configured to produce biodiesel feedstocks and fertilizer as a byproduct while removing BOD and TSS pollutants to meet the city sewer or downstream POTW discharge limits.

In one implementation, the system includes an inlet coarse screen to remove grit, debris, and small rocks, a primary circular zoned dissolved air and/or ozone flotation (CZDAOF) unit to remove and to recover FOG, a bio-dissolved air and/or ozone flotation (bio-DAF) unit to further remove BOD and TSS, and a three-phase centrifuge to process recovered FOG and produce biodiesel feedstocks and fertilizer.

In some cases, the primary CZDAOF unit may be configured to receive screened trap grease wastewater. The primary CZDAOF unit may remove and/or recover FOG while removing BOD and TSS contaminants via a series of flotation zones. In some implementations, a gaseous material dissolving system may be in fluid communication with the primary CZDAOF unit to dissolve gases (such as ozone and/or air) into fluid that mixes with the wastewater in the primary CZDAOF unit. When exposed to the atmosphere, the dissolved gases form microbubbles that may attach to and assist with the removal of the FOG.

In one implementation, the primary CZDAOF unit may include a central entry column and the series of substantially circular or ring-shaped flotation zones that are arranged in concentric series around the central entry column. In some cases, the central column may receive brown grease or screened trap grease wastewater transferred from a holding tank via a feed pump. In some cases, the flotation zones may be annular or have a conical shaped or sloped exterior/bottom wall(s) to assist with the collection of heavy or solid particles in the brown grease. For example, the depth of each of the consecutive flotation zones may be reduced to allow for the waste sludge to be collected via one or more primary bottom sludge discharge ports.

In some implementations, each of the flotation zones as well as the central entry column may include independent pressured dissolved air diffusers that introduce microbubbles into the wastewater and/or effluent. As discussed above, the microbubbles attach on the surface of FOG or suspended solid particles within the wastewater. The attached microbubbles then cause the FOGs or particles to float upward where the FOGs or particles may be extracted from the wastewater.

The primary CZDAOF unit may include a primary scum scraper assembly positioned along the top of the primary CZDAOF unit to remove the FOG and solid particle scum from the surface of the wastewater within each of the flotation zones of the primary CZDAOF unit and deposit the FOG and solid particle scum into a scum collection trough. For example, as the microbubbles raise the FOG and solid particle scum to the surface, the primary scum scraper assembly may skim, trap, and remove the FOG from the primary CZDAOF unit.

In some cases, the flow direction of the wastewater is reversed in each successive flotation zone. This counter-current flow pattern (known as a “plug flow pattern”) slows the rate of travel of the wastewater through the primary CZDAOF unit, causing increased exposure of the wastewater to the flotation zones, thereby increasing chances for FOG to attach to the microbubbles and be removed by the scrum scraper assembly.

In some implementations, the primary CZDAOF unit may be configured to introduce the microbubbles into the system via recirculated effluent. For example, the primary CZDAOF unit may dissolve the microbubbles into effluent produced by the system and then reintroduce the effluent into the flotation zones via the independent pressure dissolved air diffusers. For example, the primary CZDAOF unit may include an effluent reservoir (such as via a weir tank) coupled to an exit port of the exterior flotation zone (e.g., the final flotation zone or the polishing zone) to collect the effluent after the sludge and the FOGs have been removed.

The primary CZDAOF unit may also include a gaseous material dissolving system coupled to the effluent weir tank such that the gaseous material dissolving system may receive at least a portion of the effluent produced by the primary CZDAOF unit. The gaseous material dissolving system may include one or more pumps to dissolve the gaseous material into the effluent.

The bio-DAF unit may be an integrated physiochemical and biochemical wastewater treatment system that includes a central entry column, an aerobic bio-media reactor (such as a four-stage aerobic bio-media reactor), and a secondary DAF unit. The central entry column of the bio-DAF unit maximizes FOG and light particulates removals due to the lower uprising velocities of particulates and FOG. The bio-media reactors may be used to biodegrade and remove organic matter and nutrients. For example, each stage of the aerobic bio-media reactor develops and accumulates optimized bacteria species and/or microorganisms systems based on BOD and nutrient levels in the wastewater. The bio-media treatment process is based on attached growth biofilm principles by eliminating the returning activated sludge. Floating plastic media are kept inside the reactors to provide a place for bacteria and/or microorganism growth.

In some implementations, aeration may be supplied to the aerobic reactors to provide oxygen for microbial growth and cause mixing to fully disperse the plastic media throughout the reactors. Mixing also serves as a measure to control the biofilm thickness on the plastic media. Aeration and turbulence help to maintain a desired biofilm thickness, as the turbulence causes extra or excess biomass to be stripped from the plastic media and flow out of the bio-media reactors along with the treated effluent.

In some instances, suspended solid mixtures are captured and removed in the downstream secondary DAF unit of the bio-DAF unit. For example, the secondary DAF unit may be used to separate suspended solids, stripped biomass and small particulates from the bio-media reactor effluent in a manner similar to the primary CZDAOF unit. The effluent discharged from the secondary DAF effluent meets the downstream city sewer or POTWs discharge requirements for BOD and TSS and, thus, reduces the costs associated with BOD and TSS discharge surcharges. In some situations, the system, discussed herein, may also be installed near metropolitan areas to be closer to the points of brown or trap grease generation and, thereby, save transportation and disposal costs.

In one particular example, a secondary scum collection assembly may be positioned over the secondary DAF unit to collect and remove additional FOG prior to discharging the effluent to the downstream sewer system. The secondary scum collection assembly, similar to the primary scum collection assembly, may be configured to skim FOGs and solid particles from the surface of the wastewater in the secondary DAF unit and discharge the collected FOG into a scum collection chute.

Thus, the system provides a sustainable brown grease treatment and disposal system for removing and recovering FOG from restaurant trap grease wastewater to produce usable biodiesel feedstocks and fertilizer. In some implementations, a three-phase centrifuge can be used to produce biodiesel feedstocks and fertilizer from the recovered FOG.

In some cases, the units of the system may be configured to have a modular design. The modular design of units enables each of the units to be split into smaller modular components for easier shipping and allows for a unit of any desired diameter or number of flotation zones to be constructed on-site. Additionally, the circular walls between the flotation zones may be formed from thinner material, due to the inherent strength provided by cylindrical symmetry. For example, allowing the use of thinner stainless steel provides a cheaper manufacturing alternative and lower maintenance costs than conventional designs.

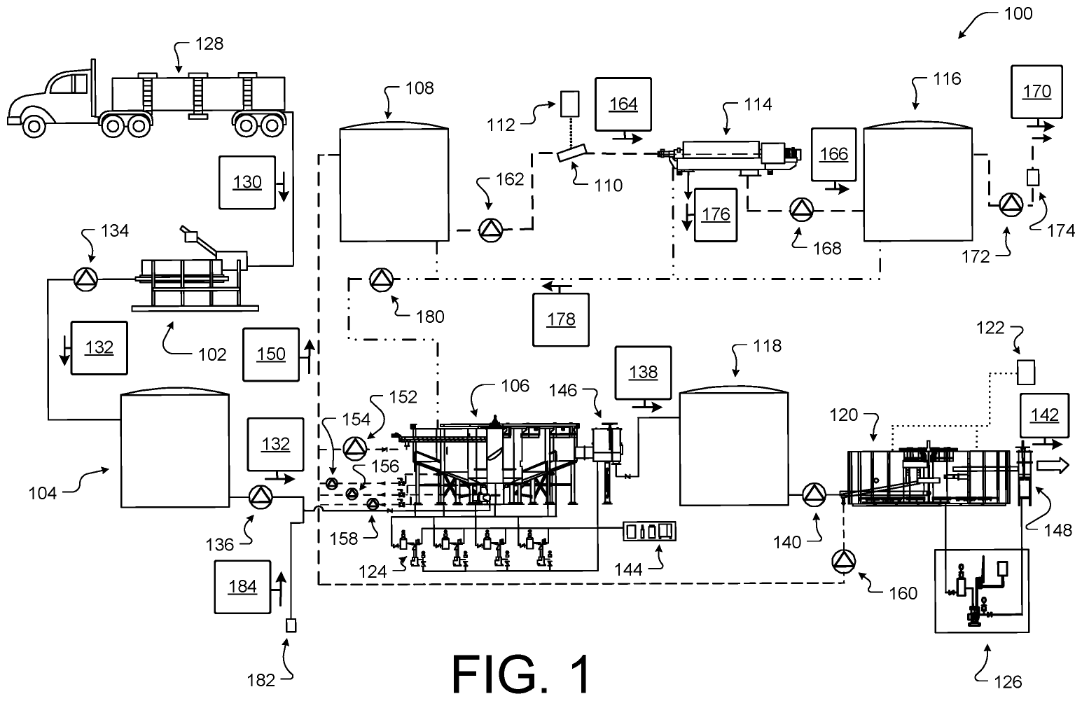

FIG. 1 illustrates a block diagram view of an example resource recovery system 100 for processing wastewater according to some implementations. The system 100 includes an inlet coarse screen 102, an equalization (EQ) tank 104, a primary CZDAOF unit 106, a FOG preheat tank 108, a pick heater 110, a boiler 112, a three-phase centrifuge 114, finished oil tank 116, bio-DAF feed tank 118, bio-DAF unit 120, blower 122, a primary gaseous material dissolving system 124, a secondary gaseous material dissolving system 126 as well as other equipment that will be discussed in more detail below.

In general, brown or trap grease wastewater can contain trash, grit, small rocks, and/or debris. These materials must be caught and removed to protect subsequent pumps, pipelines, and tanks of the system 100 from damage. As depicted in FIG. 1, a hauling truck 128 initially dumps trap grease wastewater 130 into the inlet coarse screen 102. The inlet coarse screen 102 operates to remove trash, debris, grit, and small rocks (e.g., larger debris) from the brown or trap grease wastewater 130. In some cases, the inlet coarse screen 102 is designed to remove large debris and objects to protect the subsequent pumps and piping operations without removing significant amounts of FOG from the brown trap grease wastewater 130. For example, the inlet coarse screen 102 may include one or more coarse screens, one or more screw conveyors, and/or one or more steam spray washing systems. In some cases, the coarse screens may be a heavy-duty industrial screen for handling wastewater having a high FOG content. In some situations, steam may be applied or used to spray and wash the inlet coarse screen 102 to prevent FOG attaching on the surface of equipment.

After screening by the inlet coarse screen 102, the screened trap grease wastewater 132 is transferred into the EQ tank 104 by a pump 134. Since trap grease wastewater hauling trucks 128 usually work during daytime to collect and transport the trap grease wastewater 130 from restaurants, fast-food chains, and other establishments, the EQ tank 104 is configured with sufficient volume to hold half of the design flow capacity of the brown grease treatment and disposal system 100. While the screened trap grease wastewater 132 is within the EQ tank 104, steam may be injected to maintain a desired temperature to avoid FOG sticking on the walls and pipes.

A feed pump 136 may be used to transfer the screened trap grease wastewater 132 from the EQ tank 104 to the primary CZDAOF unit 106. The primary CZDAOF unit 106 is configured to remove and recover FOG from the screened trap grease wastewater 130 as well as to remove BOD and TSS contaminants. For example, the primary CZDAOF unit 106 may utilize one or more flotation zones, each of which may introduce microbubbles to attach and float the FOG to the surface. For instance, the flotation zones may be in fluid communication with the primary gaseous material dissolving system 124 to receive fluid containing dissolved gases that form the microbubbles when exposed to the atmosphere in the primary CZDAOF unit 106.

In some implementations, the primary gaseous material dissolving system 124 may include one or more ozone generators, as well as additional equipment, generally indicated by 144 (e.g., one or more oxygen generators, one or more chillers, one or more air compressors, and/or one or more microbubble generators). The primary gaseous material dissolving system 124 may draw primary CZDAOF unit effluent 138 from a fill chamber of a primary CZDAOF weir tank 146.

In the illustrated example, coagulant and/or flocculant 184 may be added to one or more of the flotation zones of the primary CZDAOF unit 106 by a chemical feed system 182. For instance, in some cases, FOG recovery may be enhanced by adding the coagulant and/or flocculant 184.

The remaining primary CZDAOF unit effluent 138 not recirculated into the primary CZDAOF unit 106 by the primary gaseous material dissolving system 124 is transferred from the primary CZDAOF unit 106 to the bio-DAF feed tank 118. The bio-DAF unit 120 is fed with the primary CZDAOF effluent 138 by a pump 140. In general, the bio-DAF unit 120 has a central column for receiving the primary CZDAOF effluent 138, a four-stage aerobic bio-media reactor, and a secondary DAF unit for final polishing of the cleaned effluent 142. The bio-media treatment process is based on attached growth biofilm principles by eliminating the recycling activated sludge. For example, floating plastic media may be kept inside each of the reactors to provide a place for bacteria and microorganism growth. Aeration is supplied to the aerobic reactors by the blower 122 to provide the necessary oxygen for microbial growth as well as to cause turbulence to fully disperse the plastic media throughout the reactors. In some cases, the mixing also serves as a measure to control the biofilm thickness on the plastic media. For instance, when the biomass on the plastic media becomes too thick and heavy, the biomass detaches from the plastic media and may cause damage to the biological treatment system 100 or even system failure. In the present bio-media reactor, aeration and turbulence make the biofilm thin and fresh, because extra biomass is stripped from the plastic media and flows out with the treated effluent. These suspended solid mixtures are captured and removed in the downstream secondary DAF unit.

In some cases, the bio-media is made of high density polyethylene (HDPE) and formed in a cylindrical shape. The specific gravity of the bio-media is close to one (such as between approximately 0.97 and 1.01), so that the bio-media can be easily moved around in the reactors with biofilms attached. In some cases, the dry weight of the bio-media is about 105 kilograms per cubic meter (or in a range between 102 and 107 kilograms per cubic meter) to assure a strong media structure and that the media are not broken during aeration. The specific surface area of the bio-media is larger than approximately 500 m²/m³ to provide more surface area for bacteria and microorganism growth and multiplication.

In some cases, the bio-media treatment system 100 uses variable frequency drives (VFD) for automated speed control of the blowers 122 based on dissolved oxygen (DO) levels that are continuously monitored by a DO sensor installed in the aerobic reactors. The ability to automatically speed up, slow down or even turn off the blowers 122 based on real-time DO measurements provides greater control over the system process, allowing the system 100 to conserve energy and save money thereby improving system performance.

In some implementations, the bio-DAF unit 120 may include a secondary DAF-unit, as will be discussed in more detail below. The secondary DAF unit may be used to remove suspended solids, stripped biofilm and biomass, and small particulates introduced by the bio-media reactors, as a final stage in processing before supplying the bio-media reactor effluent 142 to the downstream sewer system. In the illustrated example, the secondary DAF unit is physically incorporated into the bio-DAF unit 120. In other cases, the secondary DAF unit may be a standalone DAF similar to the primary CZDAOF unit 106.

Similar, to the primary CZDAOF unit 106, the secondary DAF unit of the bio-DAF unit 120 may utilize microbubbles to float remaining FOG, the suspended solids, stripped biofilm and biomass, and remaining small particulates to the surface for removal from the system 100. For instance, the secondary DAF unit may include one or more flotation zones in fluid communication with the secondary gaseous material dissolving system 126 to receive fluid containing dissolved gases (such as air and/or ozone) that form the microbubbles when exposed to the atmosphere in the secondary DAF unit. In some cases, when ozone is utilized as the dissolved gas, the ozone may assist in disinfecting the bio-media reactor effluent 142 and eliminate odor in the secondary DAF unit.

In some implementations, the secondary gaseous material dissolving system 126 may include one or more ozone generator, as well as additional equipment, such as one or more oxygen generators, one or more chillers, one or more air compressors, and/or one or more microbubble generators. The secondary gaseous material dissolving system 126 may draw the bio-media reactor effluent 142 from a fill chamber of a secondary DAF unit weir tank 148 for dissolving gases and recycling back into the secondary DAF unit.

As discussed above, scum is collected from the surface of the flotation zones of the primary CZDAOF unit 106 and the flotation zones of the secondary DAF unit and sludge is collected from the bottom of the flotation zones of the primary CZDAOF unit 106 and the flotation zones of the secondary DAF unit, generally indicated as scum and sludge 150. The collected scum and sludge 150 is transferred to the FOG preheating tank 108 via respective pumps 152-160. In some cases, when ozone is used as a dissolved gas in the primary CZDAOF unit 106 and/or the secondary DAF unit, the ozone helps to increase FOG recovery efficiency and control odors from the system 100.

The scum and sludge 150 stored in the FOG tank 108 is preheated to a first desired temperature (or temperature range) and then transferred by a pump 162 through a constant-flow steam heater 110 to the three-phase centrifuge decanter 114. The constant-flow steam heater 110 may apply steam from the boiler 112 to achieve a second desired temperature (or temperature range) within the scum and sludge 150. In some specific examples, boiler 112 may also provide steam for the inlet coarse screen 102 washing and EQ tank 104 operational demands.

The three-phase centrifuge decanter 114 may process the preheated scum and sludge 164 on a batch basis for both FOG and sludge dewatering. Oil 166 from the three-phase centrifuge decanter 114 is collected and transferred to the finished oil tank 116 by a pump 168. After decanting the water in the finished oil tank 116, the finished oil 170 can be sold as biodiesel feedstock and loaded to an oil tanker for shipment by pump 172 through a flow and mass recording meter 174. In some cases, in addition to the finished oil 170, the system 100 via the three-stage centrifuge decanter 114 may output dry solids 176 that may be used to make organic fertilizer for agricultural applications.

In some cases, excess water or centrate 178 may be generated in addition to the dry solids 176 and the finished oil 170. In these cases, the excess water or centrate 178 may be transferred back to the primary CZDAOF unit 106 for processing by the primary CZDAOF unit 106 and the bio-DAF unit 120 prior to discharging into the downstream sewer system.

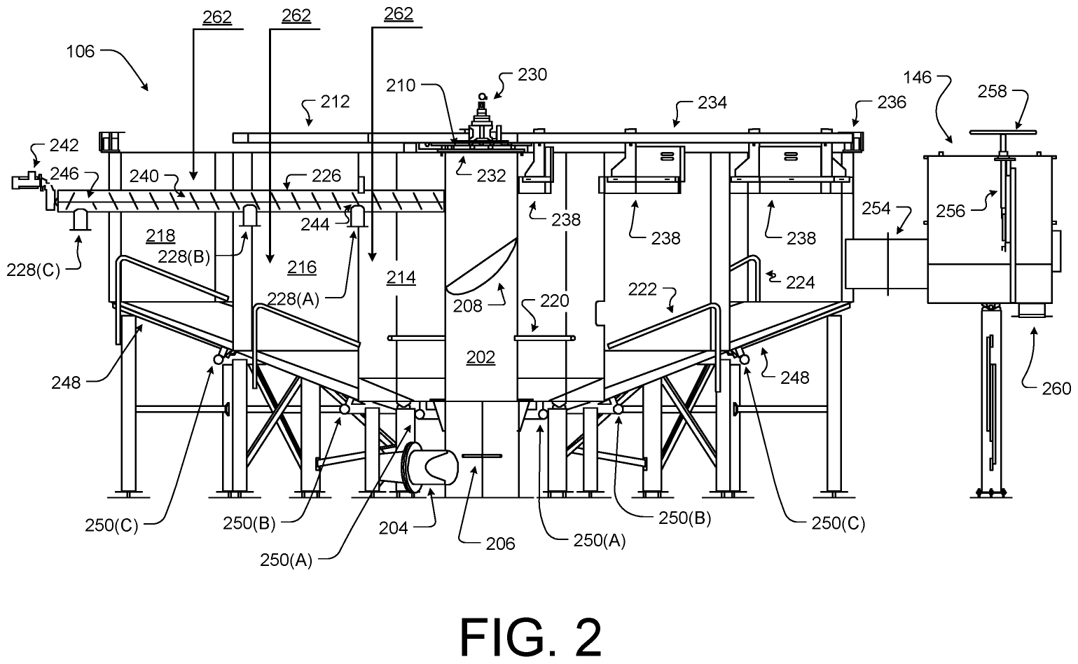

FIG. 2 illustrates a cross-sectional view of the example primary CZDAOF unit 106 of FIG. 1 according to some implementations. As discussed above, the raw wastewater is received by the CZDAOF system 106 at the central inlet column 202 via an inlet pipe 204. In one example, the central inlet column 202 may be sealed to prevent the formation of the microbubbles in the received screened trap grease wastewater until the screened trap grease wastewater including the dissolved gaseous material, such as air, ozone, chemicals, and/or other dissolved gaseous elements, is exposed to the atmosphere in the first flotation zone 214. In still other cases, the central inlet column 202 may receive the screened trap grease wastewater but not the fluid containing the dissolved gaseous materials.

In some alternative implementations, a mixture of dissolved gases (such as air and/or ozone) is introduced into the central column 202 via a diffuser 206 and mixes with the raw screened trap grease wastewater. Upon release to the atmosphere, the dissolved gases generate numerous micro-size bubbles or microbubbles. The microbubbles attach on the surface of FOG and/or suspended solid particles and cause the FOG and/or suspended solid particles to float upward. An angular guide plate 208 is mounted within the central inlet column 202 to change the flow direction and eliminate any FOG or particle accumulation on the surface of the central inlet column 202. Further, as illustrated, the central inlet column 202 may be exposed to the atmosphere, via at least openings 210 between a scum collection assembly 212 and a top surface of the central inlet column 202.

As the screened trap grease wastewater exits the central inlet column 202, the screened trap grease wastewater is processed via a series of flotation zones, such as flotation zones 214-218. In each of the flotation zones 214-218, additional microbubbles may be introduced to the screened trap grease wastewater to remove additional FOGs and solid particles via the respective diffuser 220-224. In some cases, the microbubbles attach to and raise the FOGs and solid particles to the surface. The scum collection assembly 212 then skims the surface of the screened trap grease wastewater to collect the floated FOGs and solid particles into a scum collection trough 226 and out via the discharge ports 228(A)-(C). For example, the discharge port 228(A) may collect the FOG and particles from the first flotation zone 214. The discharge port 228(B) may collect the FOG and particles from the second flotation zone 216. The discharge port 228(C) may collect the FOG and particles from the third flotation zone 218. As shown in FIG. 1, the collected FOG and particles may be provided to the FOG tank 108 for further processing. In some specific examples, the FOG and particles collected from each individual flotation zones 212-216 may be stored in separate tanks.

The scum collection assembly 212 may include a drive motor 230 configured to rotate a scum collection assembly 212. The drive motor 230 as well as the assembly 212 may be mounted on a central drive mounting pad 232. In the illustrated example, the scum collection assembly 212 also includes at least one scraper mounting arm 234, at least one corresponding side wall wheel assembly 236, and one or more scum scrapers 238 mounted below the at least one scum scraper mounting arm 234. In general, as the scum collection assembly 212 is rotated by the drive motor 230, the assembly 212 rotates over flotation zones 214-218. In some cases, the drive motor 230 may be equipped with a variable frequency drive (VFD), such that the drive motor 230 may be operable at variable speeds. In other cases, the rotation of the scum collection assembly 212 may be periodic, such that the scum collection assembly 212 may rotate for a first predefined period of time and then halt for a second predefined period of time. In some cases, the scum collection assembly 212 may rotate in the clockwise direction. During the rotations, the scum scrapers 238 mounted below the scum scraper mounting arms 234 push the scum (e.g., the floated FOGs and solid particles) accumulated on the surface of the screened trap grease wastewater into the scum collection trough 226.

The scum collection trough 226 may include a screw convey unit 240 to push the FOGs and solid particles towards the discharge ports 228(A)-(C). In some cases, a drive motor 242 may be mechanically coupled to the screw convey unit 240. The screw convey unit 240 may include one or more fin plates 244 coupled to a screw beam 246. In this example, the drive motor 242 may rotate the screw convey unit 240 to move the FOGs and solid particles deposited in the scum collection trough 226 towards the discharge port 228(A)-(C). The collected FOGs and solid particles may then be used or processed, such as when the FOGs include commercially desirable products (e.g., the finished oil and dry solids), as discussed above with respect to FIG. 1.

In the illustrated example, the bottom plate of each of the flotation zones 214-218 are sloped to collect bottom sludge and heavy particles that is included in the wastewater received via the inlet pipe 204. In each of the flotation zones 214-218 a bottom sludge assembly 248 is configured to with several sludge discharge ports 250(A)-(C) ports evenly spaced along the circumference of each of the flotation zones 214-218 to collect and discharge the heavy solids and sludge that accumulates on the bottom of each flotation zone 214-218, as discussed above. For example, the bottom plate of each flotation zone 214-218 may be sloped toward the inner zone wall to help heavy solid particles slide toward the sludge discharge ports 250(A)-(C). In one implementation, the bottom sludge discharge assembly 248 consists of a number of sludge discharge ports 250(A)-(C) and a circular sludge pipe manifold (not shown). In some implementations, each flotation zone 214-218 may have a separate bottom sludge discharge ports 250(A)-(C), as illustrated. For instance, the sludge discharge ports 250(A)-(C) may be in fluid communication with the FOG tank 108 as discussed above with respect to FIG. 1.

In the current example, the primary CZDAOF unit 106 is in fluid communication with the primary effluent weir tank 146. For instance, the third flotation zone 218 may be in fluid communication with the effluent weir tank 146 via a channel 254, such that the primary CZDAOF unit effluent exiting the third flotation zone 218 enters the primary effluent weir tank 146. The primary effluent weir tank 146 may include a weir gate 256 that is adjustable via a control handwheel 258 to control the primary CZDAOF unit effluent level in the weir tank 146. The primary CZDAOF unit effluent passes through an opening in the weir gate and is discharged through a discharge port 260 to the bio-DAF feed tank 118.

In some cases, the FOG and colloidal particulates remaining in the screened trap grease wastewater after exiting the first flotation zone 214 are further agglomerated and flocculated to form larger particulates with the help of coagulant and flocculant 262 added to the screened trap grease wastewater in the first flotation zone 214, the second flotation zone 216 and/or the third flotation zone 218.

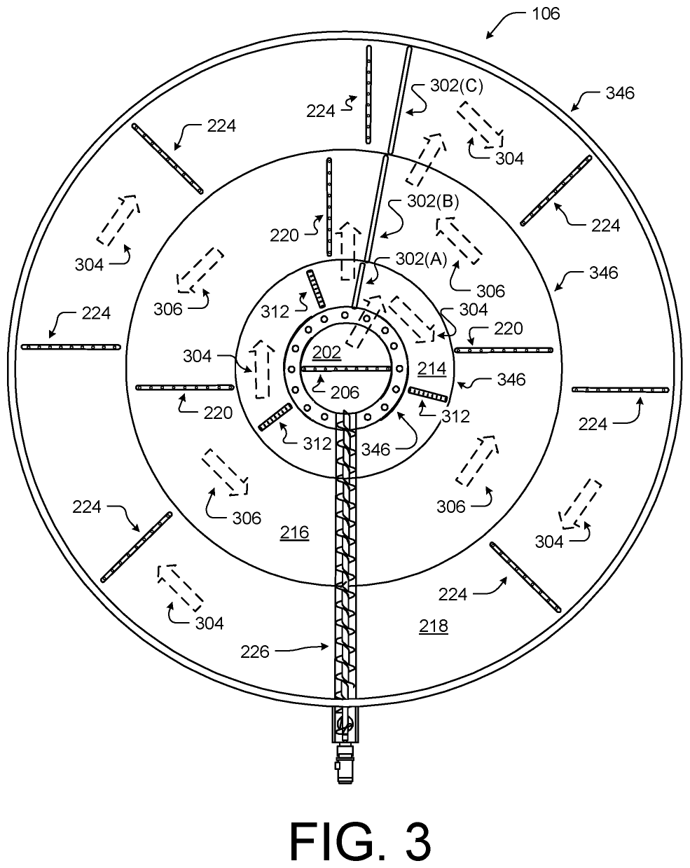

FIG. 3 illustrates a top view of an example primary CZDOAF unit 106 of FIG. 1 with scum scraper assembly removed according to some implementations. As discussed above, the primary CZDOAF unit 106 may be configured to clean screened trap grease wastewater prior to discharging the screened trap grease wastewater into a downstream sewer system. In some examples, the primary CZDOAF unit 106 may be used to recover FOG from wastewater. In the illustrated example, the example primary CZDOAF unit 106 includes a central column 202 and the series of flotation zones 214-218.

In the current example, the screened trap grease wastewater is received from a source (not shown) at the lower or bottom portion of the central column 202. As discussed above, the central column 202 may be configured to introduce microbubbles, via pressurized recirculated primary CZDOAF unit effluent, into the screened trap grease wastewater. For instance, in one example, the pressurized recirculated primary CZDOAF unit effluent containing the mixture of dissolved gases (such as air and/or ozone) is introduced to the screened trap grease wastewater via a diffuser pipe 206. Upon release to the atmosphere within the first flotation zone 204, the dissolved gases in the pressurized recirculated primary CZDOAF unit effluent generates numerous microbubbles. The microbubbles attach on the surface of the FOG or suspended solid particles and cause the FOG and the particles to float upward. The FOG and the particles may then be removed from the surface the primary scum scraper assembly (not shown) and the scum collection trough 226.

The first flotation zone 214 extends radially around the central column 202 and is in fluid communication with the central column 202. Similar to the central column 202, the first flotation zone 204 may introduce microbubbles into the screened trap grease wastewater by introducing additional pressurized recirculated primary CZDOAF unit effluent via at least one diffuser 220. In the illustrated example, the diffusers 220 are a circular dissolved air diffuser, however, in other examples, the diffuser 220 may be multiple dissolved diffusers evenly distributed around the first flotation zone 214.

The second flotation zone 216 extends radially outward around the first flotation zone 214 and is configured in fluid communication with the first flotation zone 214, such that when the screened trap grease wastewater exits the first flotation zone 214, the screened trap grease wastewater enters the second flotation zone 216. In various implementations, the primary CZDOAF unit 106 may be configured with baffles, generally indicated by 302(A)-(C), that allow the wastewater within the flotation zones 214-218 to flow in different directions. For instance, in some examples, the baffles 302(A)-(C) may be configured such that the screened trap grease wastewater within the first flotation zone 214 flows in a first direction, generally indicated by 304, opposite a second direction, generally indicated by 306, to the screened trap grease wastewater within the second flotation zone 216. For instance, in the illustrated example, the screened trap grease wastewater in the first flotation zone 214 flows in a clockwise direction while the screened trap grease wastewater in the second flotation zone 216 flows in a counter-clockwise direction.

Alternately, the screened trap grease wastewater in the first flotation zone 214 flows in a counter-clockwise direction while the wastewater in the second flotation zone 216 flows in a clockwise direction. By changing the direction of flow of the screened trap grease wastewater using baffles 302(A)-(C) within each flotation zone 214-218, the primary CZDOAF unit 106 can slow the rate of flow of the screened trap grease wastewater and, thereby, increase the time the screened trap grease wastewater is within each flotation zone 214-218. In some cases, the baffles 302(A)-(C) may include textures, protrusions, or other configurations that may cause the screened trap grease wastewater to be disturbed and/or slow.

Within the second flotation zone 216, microbubbles of dissolved gases, such as air and/or ozone, are again injected through a number of dissolved air diffusers 222. Again, the microbubbles may attach to additional FOGs and suspended solid particles not removed in the central column 202 or the first flotation zone 214. The FOGs and particles attached to the microbubbles in the wastewater again raise to the surface and may be collected in the scum collection trough 226 by the primary scum collection assembly 212.

In the illustrated example, a third flotation zone 218 extends radially outward around the second flotation zone 216 and is configured in fluid communication with the second flotation zone 216, such that when the screened trap grease wastewater exits the second flotation zone 216, the screened trap grease wastewater enters the third flotation zone 218. The primary CZDOAF unit 106 is further configured such that the screened trap grease wastewater within the third flotation zone 218 flows in the first direction 304 opposite the second direction 306 of the screened trap grease wastewater within the second flotation zone 216 (e.g., the screened trap grease wastewater in the third flotation zone 218 flows in the same direction as the screened trap grease wastewater within the first flotation zone 214).

Within the third flotation zone 218, microbubbles of dissolved gases, such as air and/or ozone, are again injected through a number of dissolved air diffusers 224. Again, the microbubbles may attach to additional FOGs and suspended solid particles not removed in the central column 202, the first flotation zone 214, or the second flotation zone 216. The FOGs and particles attached to the microbubbles in the wastewater again raise to the surface and may be collected in the scum collection trough 226 by the primary scum collection assembly 212.

In some cases, the FOG and colloidal particulates remaining in the screened trap grease wastewater after exiting the first flotation zone 214 may be further agglomerated and flocculated to form larger particulates with the help of coagulant and flocculant added to the screened trap grease wastewater in the second flotation zone 216 and/or the third flotation zone 218. The addition of the coagulant and flocculant, in the second flotation zone 216 and/or third flotation zone 218 assist in significantly reducing the BOD and TSS loadings in the primary CZDOAF unit effluent.

In the various implementations discussed herein, the relative sizes of each of the flotation zones 214-218 may vary and may be determined based on process requirements of the wastewater. In some cases, the flotation zones 214-208 may be separated by vertical zone walls 308 that are arranged in concentric configuration. Additionally, while the primary CZDOAF unit 106 is shown having three substantially circular flotation zones 214-218, it should be understood that the number of flotation zones as well as the shape may vary from implementation to implementation. Thus, in various implementations, the primary CZDOAF unit 106 may be configured with one or more flotation zones.

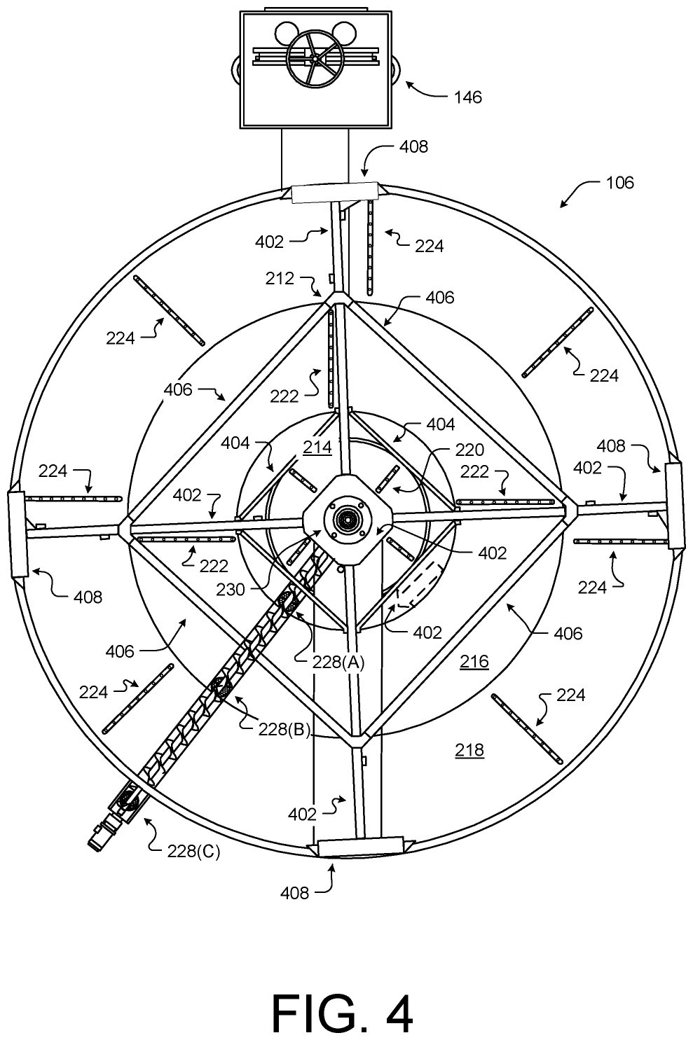

FIG. 4 illustrates another top view of the example the primary CZDAOF unit 106 of FIG. 1 according to some implementations. As discussed above in FIG. 1, the primary CZDAOF unit 106 may include a central inlet column (shown as sealed to the atmosphere by a central drive mounting pad 232) and a series of flotation zones, such as flotation zones 214-218, arranged about the central inlet column.

In the current example, the screened trap grease wastewater is received from a source (such as a hauler truck) at the lower or bottom portion of the central inlet column. In the current example, the scum collection assembly 212 is shown positioned over the primary CZDAOF unit 106. The scum collection assembly 212 may be configured to skim FOGs and solid particles from the surface of the wastewater within each of the flotation zones 214-218 and deposit the FOG and solid particles into the scum collection trough 226. The scum collection trough 226 may then push the collected FOG and solid particles out of the primary CZDAOF unit 106 via one or more discharge ports, generally indicated by 228(A)-(C). For example, the scum collection trough 226 may discharge FOG and solid particles from the first flotation zone 214 via discharge port 228(A), FOG and solid particles from the second flotation zone 216 via discharge port 228(B), and FOG and solid particles from the third flotation zone 218 via discharge port 228(C).

The scum collection assembly 212 may include a drive motor 230 configured to rotate a scum collection assembly 212. The drive motor 230 as well as the assembly 212 may be mounted on a central drive mounting pad 232. In the illustrated example, the scum collection assembly 212 also includes four scraper mounting arms, generally indicated by 402, four inner structural beams, generally indicated by 404, four outer structural beams, generally indicated by 406, four side wall wheel assemblies, generally indicated by 408, and a scum scraper (not shown) coupled to each of the scum scraper mounting arms 402. While the illustrated example has four scarper mounting arms 402, four inner structural beams 404, and four outer structural beams 406, it should be understood that in other implementations, different numbers of scarper mounting arms 402, inner structural beams 404, and outer structural beams 406 may be used, such as two or six.

In general, as the scum collection assembly 212 is rotated by the drive motor 230, the assembly 232 rotates over flotation zones 214-218 via the four side wall wheel assemblies 408. During the rotations, the scum scrapers mounted below the scum scraper mounting arms 402 push the scum (e.g., the floated FOGs and solid particles) accumulated on the surface of the screened trap grease wastewater into the scum collection trough 226. For example, as the scum collection assembly 232 rotates one or more scum scrapers within each of the flotation zones 214-218 may be positioned to push the FOGs and solid particles floated by the microbubbles into the scum collection trough 226 where the collected FOG and solid particles may be provided to the FOG tank 108 via the respective discharge ports 228(A)-(C).

As discussed above, each of the flotation zones 214-218 may include diffusers, such as illustrated diffusers 220-224, to introduce fluid or recirculated primary CZDOAF unit effluent having dissolved gases (such as air and/or ozone) that produce microbubbles when exposed to the atmosphere after exiting the diffusers 220-224. In the current example, the primary CZDOAF effluent exits out of the third flotation zone 218 into the primary weir tank 146. Thus, the third flotation zone 218 and the primary weir tank 146 are in fluid communication.

In the current example, the primary CZDAOF unit 106 may be configured to be fabricated using 304L or 316L, stainless steel, or a series of duplex stainless. For instance, stainless steel does not need to be painted or coated in some manner, and therefore can be more economical. Further, the circular shape of the CZDAOF unit 106 allows the side zone walls to be in hoop stress, enabling the CZDAOF unit 106 to be built to almost any diameter using lighter, thinner materials than conventional rectangular CZDAOF units. Additionally, to address potential shipping problems due to size, the CZDAOF unit 106 may be fabricated in a number of flanged sections or modules that can be easily transported in pieces and assembled at the construction site. This allows the CZDAOF unit 106 to be of any desired diameter to be built and shipped to meet the requirements of the project at hand, and also reduces transportation costs when compared to conventional units.

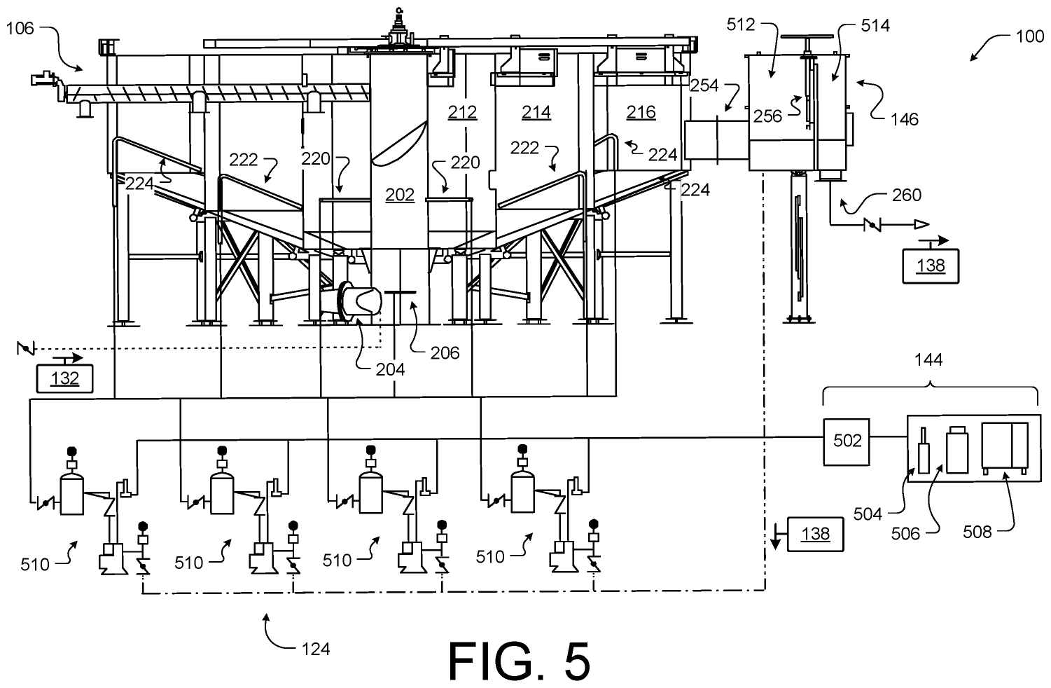

FIG. 5 illustrates a partial view of an example resource recovery system 100 of FIG. 1 including the primary CZDAOF unit 106, the primary gaseous material dissolving system 124, the primary weir tank 146, and the equipment 144 according to some implementations. As discussed above, screened trap grease wastewater 132 enters the CZDAOF unit 106 via the inlet pipe 204 coupled to the central inlet column 202, as discussed above. Likewise, the primary CZDAOF unit effluent 138 exits the primary CZDAOF unit 106 via a channel 254 and into the primary weir tank 146. In some implementations, some portion of the primary CZDAOF unit effluent 138 may be recirculated to the gaseous material dissolving system 124, as shown. In the illustrated example, the gaseous material dissolving system 124 and additional equipment 144 includes an ozone generator 502, oxygen generator 504, chiller 506, air compressor 508, and one or more microbubble generators 510. The gaseous material dissolving system 104 may draw cleaned effluent 138 from the outfall chamber 514 of the weir tank 146. The primary weir tank 146 may include an adjustable weir gate that controls the water level in the primary CZDAOF system 106. When this filling chamber 512 is full (e.g., more cleaned effluent 138 is in the filling chamber 512 than the gaseous material dissolving system 124 may consume), the excess primary CZDAOF unit effluent 138 overflows the adjustable weir 256 into the outfall chamber 514 and is discharged through the discharge port 260 to the bio-DAF feed tank.

In general, the microbubble generators 510 may cause the air, ozone and/or other gases (e.g., nitrogen) to be dissolved into the primary CZDAOF unit effluent 138 under high pressure. The primary CZDAOF unit effluent 138 including the dissolved gases may then be provided via fluid communication to corresponding dissolved air diffuser, such as diffusers 206, 220, 222, and 224. In the illustrated example, each of the microbubble generators 510 are in fluid communication with each of the central inlet column 202 and the flotation zones 214-218. However, in alternative implementations, each of the microbubble generators 510 may dissolve gases into cleaned effluent 138 being supplied to select ones of the diffusers 206, 220, 222, or 224, such as when different gases are dissolved for use in different flotation zones 214-218.

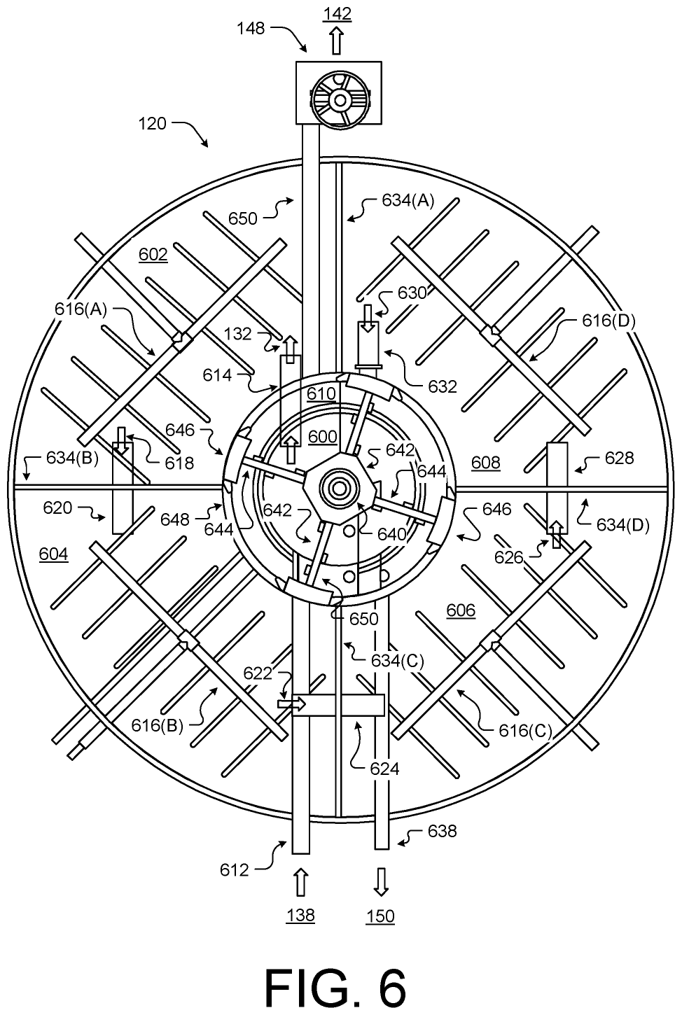

FIG. 6 illustrates a top view of the example bio-DAF unit 120 according to some implementations. As discussed above, the bio-DAF unit 120 may be used to remove organic matter, suspended solids, and nutrient removal from the primary CZDAOF unit effluent 132. The bio-DAF unit 120 includes a central column (not shown), multiple-stage aerobic bio-media reactors including aerobic bio-media reactor 602-608, and a secondary DAF unit 610. The bio-DAF unit 120 may also be coupled to ancillary equipment, such as a gaseous material dissolving system and blowers, as discussed above with respect to FIG. 1.

In general, the primary CZDAOF unit effluent 138 is received via an inlet pipe 612 at the central column 600. In some implementations, the primary CZDAOF unit effluent 132 is mixed with secondary DAF effluent having dissolved gases (such as ozone and/or air). The primary CZDAOF unit effluent 138 transfers into first stage aerobic bio-media reactor 602 from the central column 600. For instance, an screen cage 614. A screen cage may cover the central column effluent pipe 614 exit to stop bio-media from the bio-media reactor 602 back into the central column 600.

Within the first stage bio-media reactor zone 602, air and/or oxygen is provided by an aeration system including the blowers 122. The air and/or oxygen may be distributed through a diffuser assembly (e.g., a coarse bubble diffuser) 616(A). Bio-media in the first stage aerobic bio-media reactor zone 602 may be loaded in at a first pre-designated filling ratio. Since the influent organic loading may be high in the primary CZDAOF unit effluent 138, fast-growing bacteria species may be selected to dominate in the first stage aerobic bio-media reactor zone 602. Thus, the organic matter and BOD can be oxidized and biodegraded into carbon dioxide and water through metabolism of the microorganism system. The air and/or oxygen provided by the diffuser assembly 616(A) provides for microorganism growth as well as causes water flow for moving and rotating the bio-media within the reactor to avoid biofilm soaring on the surface of the bio-media.

First stage aerobic bio-media reactor effluent 618 enters the second stage aerobic bio-media reactor zone 604, for instance, through a second screen cage 620. The incoming organic loading of the effluent 618 may be significantly reduced, as the effluent 618 has been processed by the first stage aerobic bio-media reactor 602. Again, a microorganism system suitable for the available organic matter level is developed within the second stage aerobic bio-media reactor zone 604 and dominating bacteria species may be built up. Again, air and/or oxygen is provided by the blowers 122 and distributed in the second stage aerobic bio-media reactor zone 604 through a diffuser assembly 616(B), such as a coarse bubble diffuser assembly. In the second stage aerobic bio-media reactor 604, bio-media may be loaded at a second pre-designated filling ratio. In the second stage aerobic bio-media reactor 604, the organic matter and BOD can be further biodegraded and oxidized into carbon dioxide and water through metabolism of microorganisms. Again, the air and/or oxygen provided via the diffuser 616(B) acts to cause water flow to move and rotate the bio-media within the reactor and to, thus, avoid biofilm soaring on the surface of bio-media.

Second stage aerobic bio-media reactor effluent 624 enters the third stage aerobic bio-media reactor zone 606 through a third screen cage 624. The incoming organic loading of the effluent 624 may be significantly reduced, as the effluent 624 has been processed by the first and second stage aerobic bio-media reactor 602 and 604. Again, a microorganism system suitable for the available organic matter level is developed within the third stage aerobic bio-media reactor zone 606 and dominating bacteria species may be built up. Again, air and/or oxygen is provided by the blowers 122 and is distributed in the third stage aerobic bio-media reactor 606 through a diffuser assembly 616(C), such as a coarse bubble diffuser assembly. Bio-media may be loaded in the third stage aerobic bio-media reactor 606 based on a third pre-designated filling ratio. Again, the air and/or oxygen provided via the diffuser 616(C) acts to cause water flow to move and rotate the bio-media within the reactor 606 and to, thus, avoid biofilm soaring on the surface of bio-media.

In some cases, the third stage aerobic bio-media reactor effluent 626 enters the fourth stage aerobic bio-media reactor zone 608 through a fourth standard screen cage 628. Through biodegradation in the first, second, and third stage aerobic bio-media reactors 602-606, the majority of BOD has been consumed and removed. In one example, aerobic autotrophic bacteria species may become the dominating species in the third stage aerobic bio-media reactor 608. Again, air and/or oxygen is provided by the blowers 122 and is distributed in the third stage aerobic bio-media reactor 606 through a diffuser assembly 616(D), such as a coarse bubble diffuser assembly. Bio-media may be loaded in the third stage aerobic bio-media reactor 606 based on a fourth pre-designated filling ratio. Again, the air and/or oxygen provided via the diffuser 616(D) acts to cause water flow to move and rotate the bio-media within the reactor 608 and to, thus, avoid biofilm soaring on the surface of bio-media. In some cases, the fourth stage aerobic bio-media reactor effluent 630 enters the secondary DAF unit 610 through a standard screen cage 632 (and, in some cases, a pipe) to further separate biomass and TSS from effluent 630.

In the illustrated example, the aerobic bio-media reactor 602-608 of the bio-DAF unit 120 are formed as four sections. Each reactor 602-608 may be configured to propagate and accumulate specific bacteria and microorganisms based upon the food source, nutrient level, air supply, and environmental conditions. As discussed above, screen cages 614, 620, 624, and/or 632 may be installed at the exit/entrance of each reactor 602-608 to retain the bio-media, bacteria, and microorganisms in their respective reactor 602-608. Thus, the bio-media, bacteria, and microorganisms within each of the reactor 602-608 are maintained in an environment that is configured to maximize biomass production rates.

Partition walls, such as partition walls 634(A)-(D), may be used to divide the aerobic bio-media reactor 602-608 of the bio-DAF unit 120 into the four different functional zones. In some situations, to address potential shipping problems due to size, the reactor 602-608 may be fabricated as individual flanged sections that may be more easily transported in pieces and assembled at a construction or operational site. Thus, of the bio-DAF unit 120 of any desired diameter maybe fabricated, shipped to a location, and assembled on site to meet the requirements of the project at hand while still reducing overall transportation costs when compared with conventional systems.

In the illustrated example, the secondary DAF unit 610 is used to remove any combination of suspended solids, stripped biofilm, TP and small particulates from the bio-media reactor effluent 630. In cases in which TP removal is necessary, alum and a small amount of flocculant can also be added in the secondary DAF unit 610. In particular, the secondary DAF unit 610 extends radially outward around the central column 600, as shown. Biomass and TSS in the aerobic bio-media reactor effluent 630 may be floated by dissolved gasses (such as, air and/or ozone) introduced into the secondary DAF unit 610. For example, gases may be dissolved in recycled bio-DAF effluent 142 by the secondary gaseous material dissolving system 126. The recirculated effluent containing the dissolved gases may be injected through several diffuser pipes (not shown) above the bottom of the secondary DAF unit 610. Upon exposure to the atmosphere within the secondary DAF unit 610, the dissolved gases form microbubbles that may attach and float the remaining biomass and TSS and raise them to the surface where the remaining biomass and TSS may be removed via a secondary scum collection assembly 634.

In the current example, the secondary scum collection assembly 634 is shown positioned over the secondary DAF unit 610. The secondary scum collection assembly 634 may be configured to skim FOGs and solid particles from the surface of the secondary DAF units 610 and discharge the FOG and solid particles 150 into the scum collection trough or chute 638. The scum collection assembly 634 may include a drive motor 640 configured to rotate a scum collection assembly 634. The drive motor 640 as well as the assembly 634 may be mounted on a central drive mounting pad 642. In some implementations, the central drive motor 640 may be equipped with a VFD. In some cases, the central drive motor 640 may cause the assembly 634 to continuously rotate in a clockwise direction. In other cases, the central drive motor 640 may cause the assembly 634 to continuously rotate in a counter-clockwise direction.

In the illustrated example, the scum collection assembly 634 also includes four scraper mounting arms 642 coupled to four side wall wheel assemblies 646. The four side wall wheel assemblies 646 may be configured to mount over the secondary DAF unit wall 648, such that the drive motor 640 may cause the assembly 634 to rotate on over the primary and secondary DAF units 610 as the wheel assemblies 646 rotate about the secondary DAF unit wall 648.

The scum collection assembly 634 includes a scum scraper mounted to the scraper mounting arms 644 to collect floated scum from the secondary DAF unit 610. Scum 150 collected in the chute 638 may be discharged using gravity and transferred to the FOG tank via a pump, as discussed above. The bio-DAF effluent 142 is then provided to the secondary DAF unit weir tank 148 after exiting the secondary DAF unit 610 via outlet pipe 650. In some cases, the bio-DAF effluent 142 may be recycled back into the secondary DAF unit 610. For example, the bio-DAF effluent 142 may be used to dissolve gases which are then mixed with the bio-DAF effluent 142 and re-introduced into the secondary DAF unit 610 to form the microbubbles.

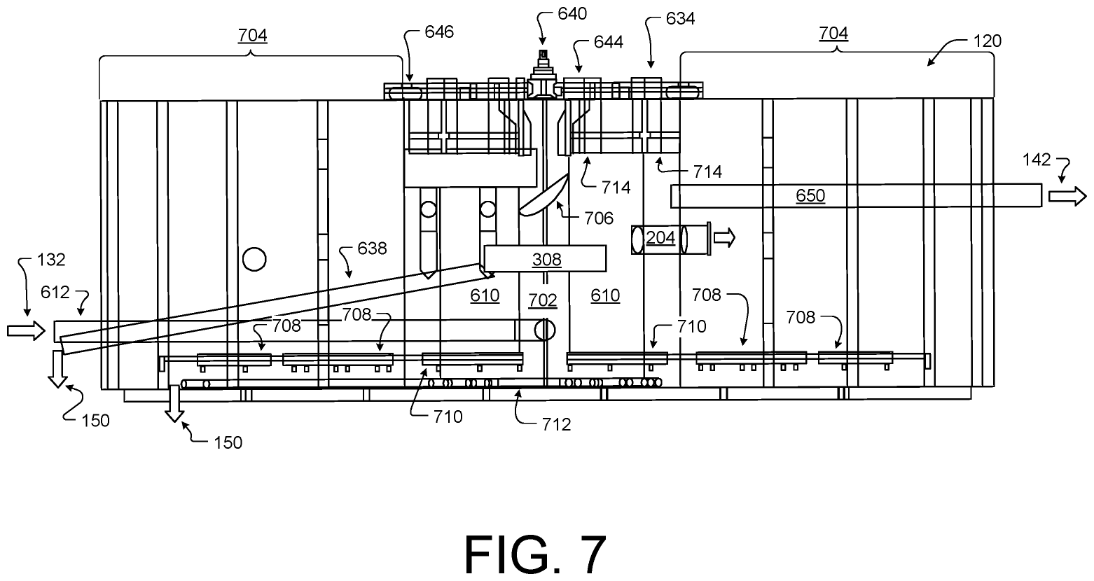

FIG. 7 illustrates a cross-sectional view of the bio-DAF unit 120 of FIG. 1 according to some implementations. The bio-DAF unit 120 includes a central column 702, the multiple-stage aerobic bio-media reactors 704, and secondary DAF unit 610. The multiple-stage aerobic bio-media reactors 704 may be divided into multiple independent reactors, such as the bio-media reactors 602-608 discussed above with respect to FIG. 6.

In some implementations, the central column 702 may be used to introduce and distribute primary CZDAOF effluent 138 into the bio-DAF unit 120. As discussed above, the primary CZDAOF effluent 138 may be received via an inlet pipe 612 such that the primary CZDAOF effluent 138 enters the central column 702 near the bottom. The central column 702 provides FOG and light particulate removal based on the lower uprising velocities of particulates and FOG. Contemporaneously, a mixture of effluent containing dissolved gases (such as air and/or ozone) recycled from the secondary DAF unit 610 may be introduced into the central column 702. To prevent FOG accumulation on the surface of the central column 702, an angular guide plate 706 may be mounted within the central column 702. For example, the central column 702 may change the flow direction. In one implementation, the angular guide plate 706 may be mounted on the top of or near the top of the central column 702. In some examples, the central column 702 may be exposed to the atmosphere, via at least openings between a scum collection assembly 634 and a top surface of the central column 702. In an alternative implementation, the central column 702 may be sealed to prevent the formation of the microbubbles.

As discussed above, the multiple-stage aerobic bio-media reactors 704 are divided into four relatively independent functional zones. In general, the bio-media treatment process is based on attached growth biofilm principles to eliminate the returned activated sludge. In some cases, floating plastic media are kept inside the various reactors to provide a place for bacteria and microorganism growth. Aeration is supplied to the aerobic reactors to provide the necessary oxygen for the microbial growth and sufficient mixing to fully disperse the plastic media throughout the reactors. The mixing also serves as a measure to control the biofilm thickness on the plastic media. When the biomass becomes too thick and heavy to hold onto the plastic media, it is sloughed or stripped off from the plastic media. For example, the multiple-stage aerobic bio-media reactors 704 may include an aeration and turbulence introduction process. The aeration and turbulence within the multiple-stage aerobic bio-media reactors 704 keeps the biofilm thin and fresh, because extra biomass is stripped from the plastic media by the turbulence and floated by the coarse air bubbles. The extra biomass may then be captured and removed in the downstream secondary DAF unit 610. Air may be provided by the blowers and is distributed in the zones of the multiple-stage aerobic bio-media reactors 704 through one or more diffuser assemblies 708.

In the illustrated example, the secondary DAF unit 610 is used to remove suspended solids, stripped biofilm, and small particulates from the bio-media reactor effluent. In particular, the secondary DAF unit 610 extends radially outward around the central column 702 as shown. Biomass and TSS in the third stage aerobic bio-media reactor zone effluent may be floated by dissolved gasses (such as, air and/or ozone) introduced into the secondary DAF unit 610. For example, gases may be dissolved in recycled effluent by the secondary gaseous material dissolving system 126. The effluent containing the dissolved gases may be injected through several diffuser pipes, generally indicated by 710, above the bottom of the secondary DAF unit 610. Upon exposure to the atmosphere within the secondary DAF unit 610, the dissolved gases form microbubbles that may attach and float the remaining biomass and TSS. In some cases, the diffusers 710 may be individual or separate diffusers designated to the secondary DAF unit 610. The bio-DAF effluent 142 may exit from the secondary DAF unit 610 via an exit pipe 650.

In some cases, the central column 702 may also be configured to trap large solids or heavies to protect the screen cages between each of the reactors. For example, the large solids or heavy sludge 150 may collect on a bottom surface of the central column 702 where the large solids or heavy sludge 150 may be removed and/or collected by a sludge discharge assembly 712. In some cases, the sludge discharge assembly 712 may include one or more discharge ports to discharge the sludge 150 from the unit 120. In some cases, the sludge discharge assembly 712 may run along the bottom of the central column 702, the secondary DAF unit 610, and the reactors 704 to remove sludge 150 collecting on the bottom surface of each of the central column 702, the secondary DAF unit 610, and the reactors 704. The removed sludge 150 may be transferred to the FOG tank by one or more pumps.

In the current example, a scum collection assembly 634 is shown positioned over the secondary DAF unit 610. The scum collection assembly 634 may be configured to skim floated FOGs and solid particles from the surface of the effluent within the secondary DAF unit 610 and discharge the FOG and solid particles into the scum collection chute 638. The scum collection chute 638 may then push the collected FOG and solid particles 150 out of the system 120 where the FOG and solid particles 150 may be transferred to the FOG tank by one or more pumps.

As discussed above, the scum collection assembly 634 may include a drive motor 640 configured to rotate a scum collection assembly 634. In the illustrated example, the scum collection assembly 634 also includes scraper mounting arms, generally indicated by 642, side wall wheel assemblies, generally indicated by 646, and one or more scum scrapers 714 coupled to the scum scraper mounting arms 644. It should be understood that in other implementations, different numbers of scarper mounting arms 644 may be used and various structural beams (not shown) may be associated with the assembly 634.

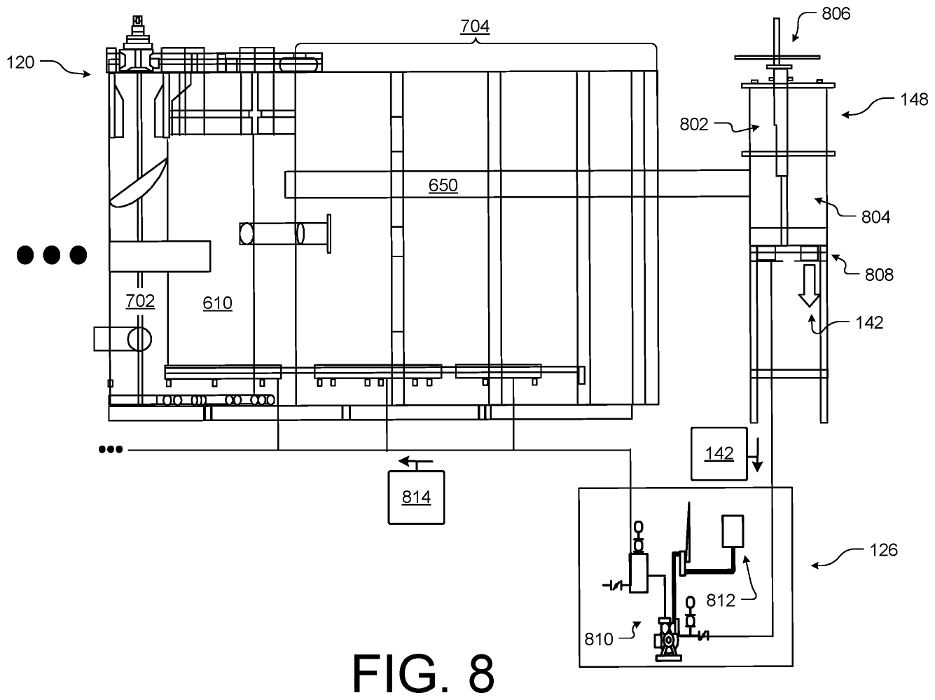

FIG. 8 illustrates a partial view of an example bio-DAF unit 120 of FIG. 1 according to some implementations. As discussed above, the bio-DAF effluent 142 may exit the bio-DAF unit 120 from the secondary DAF unit 610 via an exit pipe 650. The bio-DAF effluent 142 may exit the secondary DAF unit 610 and enter the secondary weir tank 148. The secondary weir tank 148 may include a filling chamber 802 and outfall chamber 804. In some cases, the gaseous dissolving systems 126 may draw bio-DAF effluent 142 from the fill chamber 802. An adjustable weir gate 806 is installed to control the water level in the bio-DAF unit 120. When this filling chamber 802 is full, water overflows the adjustable weir gate 806 into the outfall chamber 804. The bio-DAF effluent 142 is discharged through a discharge port 808.

The secondary gaseous material dissolving system 126 is used to provide dissolved gases (e.g., air and/or ozone) to the secondary DAF unit 610. The secondary gaseous material dissolving system 126 may include one or more microbubble generators 810 and an ozone generator 812 with associated valves and controls. The suction line of the microbubble generator 810 may be connected to the fill chamber 802 of the secondary weir tank 128 such that, for example, a mixture of air and/or ozone is injected in the suction line of the microbubble generators 810 and is dissolved into effluent 142 under high pressure. The bio-DAF effluent 142 having dissolved gases, generally indicated by 814, is then provided to the central column 702, the secondary DAF unit 610, and/or one or more of the reactors 704.

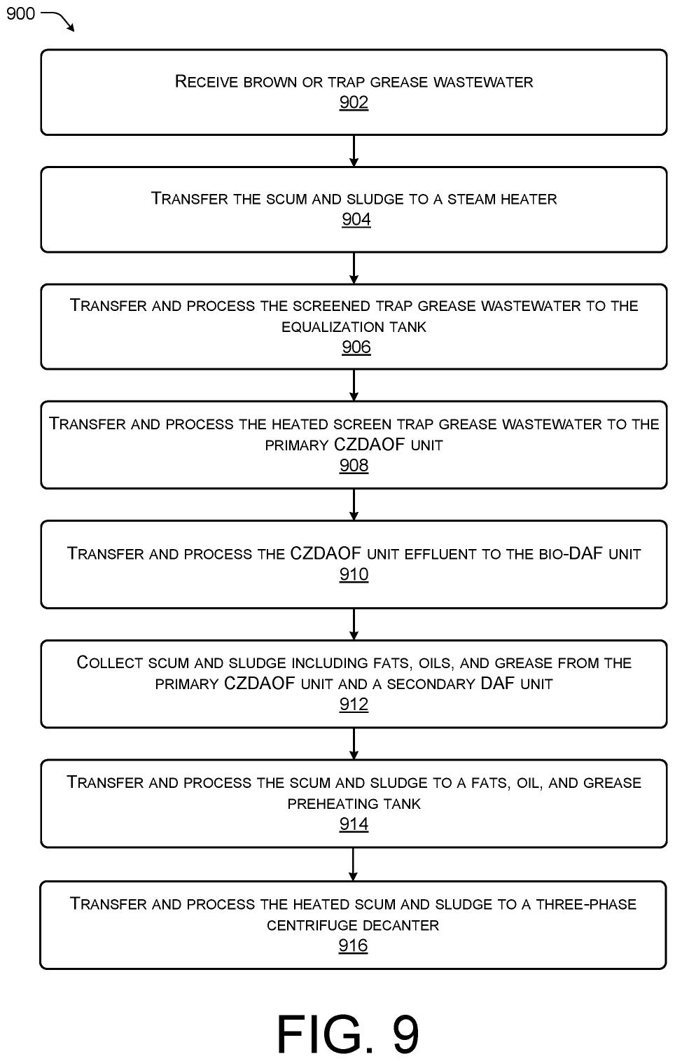

FIG. 9 is a flow diagram illustrating example processes associated with the system 100 according to some implementations. The processes are illustrated as a collection of blocks in a logical flow diagram, which represent a sequence of operations. The order in which the operations are described should not be construed as a limitation. Any number of the described blocks can be combined in any order and/or in parallel to implement the process, or alternative processes, and not all of the blocks need be executed.

FIG. 9 illustrates an example flow diagram showing a process 900 for forming finished oil and dry solids according to some implementations. As discussed above, brown grease or trap grease wastewater is collected from grease traps that are typically installed in restaurants, cafeteria, fast-food restaurant chains, and institutional food establishments to separate FOG from kitchen wastewater. Brown grease is a byproduct of cooking and comes from meat fats, lard, oil, shortening, butter, margarine, food scraps, baked goods, sauces, and dairy products. Brown grease is a mixture of FOG, food particulates, water, and kitchen waste, grit, rocks and debris that has gone down a drain and been trapped in a grease trap or grease interceptor. Brown grease in downstream sewers, WWTP, or other POTW are a leading cause of clogs, SSOs and damage to pumping stations.

The system discussed above provides a sustainable, integrated, compact, modular, environmentally and economically efficient system for removing and recovering FOG from brown grease. In some implementations, the system may be configured to produce biodiesel feedstocks and fertilizer as a byproduct while removing BOD and TSS pollutants to meet the city sewer or downstream POTW discharge limits.

At 902, the system may receive brown or trap grease wastewater from a hauling truck. For example, the truck may transport the brown or trap grease wastewater from restraints or other establishment to the processing system. Alternatively, for large facilities, the system may be established between the grease trap and the downstream sewer system.

At 904, the system may process the brown or trap grease wastewater via an inlet coarse screen. In general, brown or trap grease wastewater can contain of trash, grit, small rocks, debris. These materials must be caught and removed to protect subsequent pumps, pipeline, and tanks of the system from damage. As depicted in FIG. 1, the hauling truck initially dumps trap grease wastewater into the inlet coarse screen and the inlet coarse screen operates to remove trash, debris, grit, and small rocks (e.g., larger debris) from the brown or trap grease wastewater. In some cases, the inlet coarse screen may include one or more coarse screens, one or more screw conveyors, and/or one or more steam spray washing systems to assist with removing the larger debris.

At 906, after screening by the inlet coarse screen, the screened trap grease wastewater is transferred into the EQ tank by a pump. The EQ tank may be configured with sufficient volume to hold half of the design flow capacity of the brown grease treatment and disposal system. While the screened trap grease wastewater is within the EQ tank, steam may be injected to maintain a desired temperature to avoid FOG sticking on the walls and pipes.

At 908, the heated screened trap grease wastewater is transferred to the primary CZDAOF unit. The primary CZDAOF unit is configured to remove and recover FOG from the screened trap grease wastewater as well as to remove BOD and TSS contaminants. For example, the primary CZDAOF unit may utilize one or more flotation zones, each of which may introduce microbubbles to attach and float the FOG to the surface. For instance, the flotation zones may be in fluid communication with the primary gaseous material dissolving system to receive fluid containing dissolved gases that form the microbubbles when exposed to the atmosphere in the primary CZDAOF unit. In some cases, coagulant and/or flocculant may be added to one or more of the flotation zones of the primary CZDAOF unit by a chemical feed system.

At 910, the system transfers the primary CZDAOF unit effluent to the bio-DAF unit. For example, the bio-DAF unit may be fed with the primary CZDAOF effluent from a bio-DAF tank by a pump. In general, the bio-DAF unit has a multi-stage aerobic bio-media reactor and a secondary DAF unit for final polishing of the effluent. In some cases, the bio-media treatment process is based on attached growth biofilm principles by eliminating the recycling activated sludge. For example, floating plastic media may be kept inside each of the reactors to provide a place for bacteria and microorganism growth. Aeration is supplied to the aerobic reactors by the blower and the second to provide the necessary oxygen for microbial growth as well as to cause turbulence to fully disperse the plastic media throughout the reactors.

At 912, scum is collected from the surface of the flotation zones of the primary CZDAOF unit and the flotation zones of the secondary DAF unit and sludge is collected from the bottom of the flotation zones of the primary CZDAOF unit and the flotation zones of the secondary DAF unit.

At 914, the collected scum and sludge is transferred to the FOG preheating tank. The scum and sludge stored in the FOG tank 108 is preheated to a first desired temperature (or temperature range) and then transferred by a pump through a constant-flow steam heater to the three-phase centrifuge decanter. The constant-flow steam heater may apply steam from the boiler to achieve a second desired temperature (or temperature range) within the scum and sludge.

At 916, the three-phase centrifuge decanter may process the heated scum and sludge on a batch basis for both FOG and sludge dewatering. Oil from the three-phase centrifuge decanter is collected and transferred to the finished oil tank by a pump. After decanting the water in the finished oil tank, the finished oil can be sold as biodiesel feedstock. In some cases, in addition to the finished oil, the three-phase centrifuge decanter may output dry solids that may be used to make organic fertilizer for agricultural applications.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A system comprising:
a zoned dissolved gases flotation unit having at least one flotation zone to remove fats, oil, and grease from wastewater;
a bio-dissolved air flotation unit in fluid communication with the zoned dissolved gases flotation unit, the bio-dissolved air flotation unit including multiple-stage aerobic bio-media reactors to remove additional fats, oil, and grease from the wastewater;
a fats, oil, and grease preheating tank configure to receive the fats, oil, and grease and the additional fats, oil, and grease removed from the wastewater by the zoned dissolved gases flotation unit and the bio-dissolved air flotation unit; and
a primary gaseous material dissolving system in fluid communication with the at least one flotation zone, the primary gaseous material dissolving system to dissolve gases into a first fluid stream provided to the at least one flotation zone.

2. The system as recited in claim 1, wherein the at least one flotation zone of the zoned dissolved gases flotation unit includes a first flotation zone, a second flotation zone, and a third flotation zone, the first flotation zone in fluid communication with a second flotation zone, and the third flotation zone in fluid communication with the second flotation zone.

3. The system as recited in claim 2, wherein the primary gaseous material dissolving system is in fluid communication with the first flotation zone, the second flotation zone, and the third flotation zone.

4. The system as recited in claim 2, wherein coagulant and flocculant s introduced into the second flotation zone or the third flotation zone.

5. The system as recited in claim 1, wherein the zoned dissolved gases flotation unit and the bio-dissolved air flotation unit are substantially circular.

6. The system as recited in claim 1, further comprising a three-phase centrifuge decanter in fluid communication with the fats, oil, and grease preheating tank.

7. The system as recited in claim 1, wherein the bio-dissolved air flotation unit includes a secondary dissolved air flotation unit to remove the additional fats, oil, and grease from the bio-dissolved air and flotation unit, the secondary dissolved air flotation unit including at least one additional flotation zone.

8. The system as recited in claim 7, further comprising a secondary gaseous material dissolving system in fluid communication with the at least one flotation zone of the secondary dissolved air flotation unit, the secondary gaseous material dissolving system to dissolve gases into a second fluid stream provided to the at least one flotation zone of the secondary dissolved air flotation unit.

9. The system as recited in claim 7, further comprising:
a primary scum scraper assembly mounted over the at least one flotation zone of the zoned dissolved gases flotation unit, the primary scum scraper assembly including:
a first drive motor for rotating the primary scum scraper assembly;
a first scraper mounting arm; and
a first scraper mounted to the bottom of the first scraper mounting arm, the first scraper to push the fats, oils, and grease on a surface of the wastewater in the at least one flotation zone of the zoned dissolved gases flotation unit into a scum collection trough; and
a secondary scum scraper assembly mounted over the at least one flotation zone of the secondary dissolved air flotation unit, the secondary scum scraper assembly including:
a second drive motor for rotating the secondary scum scraper assembly;
a second scraper mounting arm; and
a second scraper mounted to the bottom of the second scraper mounting arm, the second scraper to push the additional fats, oils, and grease on a surface of the wastewater in the at least one flotation zone of the secondary zoned dissolved gases flotation unit into a scum collection chute.

10. The system as recited in claim 1, further comprising an inlet coarse screen in fluid communication with the zoned dissolved gases flotation unit, the inlet coarse screen configured to process the wastewater to remove larger debris prior to the wastewater transferring to the zoned dissolved gases flotation unit.

11. The system as recited in claim 1, wherein the multiple-stage aerobic bio-media reactor is a four-stage aerobic bio-media reactor, each stage of the four-stage aerobic bio-media reactor having a flanged shape.

12. A bio dissolved air flotation system (DAF) system comprising:
a circular central column configured to receive effluent;
a multi-stage bio aerobic bio-media reactor to receive effluent and to treat the effluent using biodegradation; and
a secondary DAF unit formed as a cylindrical ring and configured to receive bio-media reactor effluent and a second fluid having dissolved gases, the dissolved gases in the second fluid to form microbubbles within the secondary DAF unit, the secondary DAF unit positioned around an exterior wall of the circular central column and within an interior wall of the multi-stage bio aerobic bio-media reactor.

13. The system as recited in claim 12, further comprising a gaseous material dissolving system to produce the dissolved gases in a first fluid and the second fluid.

14. The system as recited in claim 12, wherein the multi-stage bio aerobic bio-media reactor is divided into four substantially flanged aerobic reactors by four partition walls.

15. The system as recited in claim 12, wherein the multi-stage bio aerobic bio-media reactor comprises:
a first aerobic bio-media reactor to receive the effluent from the circular central column and air from a blower, the first aerobic bio-media reactor configured to cultivate first microorganism system;
a second aerobic bio-media reactor to receive first aerobic bio-media reactor effluent and air from the blower, the second aerobic bio-media reactor configured to cultivate second microorganism system;
a third aerobic bio-media reactor to receive second aerobic bio-media reactor effluent and air from the blower, the third aerobic bio-media reactor configured to cultivate third microorganism system; and
a fourth aerobic bio-media reactor to receive third aerobic bio-media reactor effluent and air from the blower, the fourth aerobic bio-media reactor configured to cultivate fourth microorganism system.

16. The system as recited in claim 12, wherein the cylindrical ring secondary DAF unit includes at least one flotation zone.

17. A method comprising:
receiving heated screened trap grease wastewater at a primary circular zoned dissolved air and/or ozone flotation (CZDAOF) unit;
introducing at least one primary fluid stream into the heated screened trap grease wastewater;
collecting fat, oil and grease (FOG) from a surface of the heated screened trap grease wastewater in the primary CZDAOF unit to produce primary CZDAOF effluent;
transferring the primary CZDAOF effluent to a central column of a bio-dissolved air flotation (DAF) unit;
exposing the primary CZDAOF unit effluent to a multi-stage aerobic bio-media reactor of the bio-DAF unit to produce bio-DAF effluent;
introducing a secondary fluid stream having dissolved gases into the bio-DAF effluent within a first flotation zone of a secondary DAF unit of the bio-DAF unit;
collecting residual FOG from a surface of the bio-DAF effluent in the first flotation zone, and a second flotation zone of the secondary DAF unit;
transferring the FOG and the residual FOG to a preheat tank;
heating the FOG and the residual FOG to a desired temperature range within the preheat tank to produce heated FOG; and
transferring the heated FOG to a three-phase centrifuge decanter to produce oils centrate, and dry solid from the heated FOG.

18. The method as recited in claim 17, wherein:
receiving the heated screened trap grease wastewater at the primary circular CZDAOF unit includes receiving the heated screened trap grease wastewater by a central column of the CZDAOF unit; and
introducing at least one primary fluid stream into the heated screened trap grease wastewater includes:
introducing a first fluid stream having dissolved gases into the heated screened trap grease wastewater within the central column of the CZDAOF unit;
introducing a second fluid stream having dissolved gases into the heated screened trap grease wastewater within a first flotation zone of the CZDAOF unit;
introducing a third fluid stream having dissolved gases into the heated screened trap grease wastewater within a second flotation zone of the CZDAOF unit;
introducing a fourth fluid stream having dissolved gases into wastewater within a third flotation zone of the CZDAOF unit; and
collecting fat, oil and grease (FOG) from a surface of the heated screened trap grease wastewater in the first flotation zone, the second flotation zone, and the third flotation zone of the primary CZDAOF unit to produce primary CZDAOF effluent.

19. The method as recited in claim 17, further comprising:
receiving trap grease wastewater at an inlet coarse screen;
removing large debris from the trap grease wastewater by the inlet coarse screen to produce screened trap grease wastewater;
transferring the screened trap grease wastewater to an equalization tank; and
heating the screened trap grease wastewater to a desired temperature range within the equalization tank to produce heated screened trap grease wastewater, prior to receiving the heated screened trap grease wastewater at the primary CZDAOF unit.

20. The method as recited in claim 17, further comprising:
dissolving first gases in the at least one primary fluid stream by a primary gaseous material dissolving system; and
dissolving second gases in the secondary fluid stream by a secondary gaseous material dissolving system.
